(19) United States
(12) Patent Application Publication
(10) Pub. No.: US 2024/0276347 A1
(43) Pub. Date: Aug. 15, 2024

(54) METHOD AND DEVICE FOR PROVIDING AI/ML MEDIA SERVICE IN WIRELESS COMMUNICATION SYSTEM

(71) Applicant: Samsung Electronics Co., Ltd., Suwon-si (KR)

(72) Inventors: Eric YIP, Suwon-si (KR); Hyunkoo YANG, Suwon-si (KR)

(21) Appl. No.: 18/436,384

(22) Filed: Feb. 8, 2024

(30) Foreign Application Priority Data
Feb. 10, 2023 (KR) 10-2023-0018276

(51) Int. Cl. H04W 48/04; H04L 65/65; H04W 8/22

(52) U.S. Cl. CPC H04W 48/04; H04L 65/65; H04W 8/22

(57) ABSTRACT

A method and device for efficiently providing an artificial intelligence/machine learning (AI/ML) media service using AI/ML model split processing in a wireless communication system is provided. The method and device are related to a 5^{th} generation (5G) or 6^{th} generation (6G) communication system for supporting a higher data transmission rate. The method includes receiving, from a network server providing the AI/ML media service, service access information including at least one of information for media session handling and information for media streaming access, obtaining information on client AI media inferencing capabilities and functions, negotiating with the network server for splitting an AI media inference processing, based on the received service access information and the obtained information on client AI media inferencing capabilities and functions, and receiving, from the network server, either intermediate data or inference output data by AI model split inferencing.

### CROSS-REFERENCE TO RELATED APPLICATION(S)

This application is based on and claims priority under 35 U.S.C. § 119(a) of a Korean patent application number 10-2023-0018276, filed on Feb. 10, 2023, in the Korean Intellectual Property Office, the disclosure of which is incorporated by reference herein in its entirety.

### BACKGROUND

### 1. Field

The disclosure relates to 5^{th} generation (5G) network systems for multimedia, architectures, and procedures for artificial intelligence/machine learning (AI/ML) model transfer and delivery over 5G, AI/ML model transfer and delivery over 5G for AI enhanced multimedia services.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Artificial Intelligence (AI) is a general concept defining the capability for a system to act based on the below 2 major conditions:
The context in which a task has to be done, meaning the value or state of different input parameters.
The past experience of achieving the same task with different parameter values and the record of potential success with each parameter value.

Machine Learning (ML) is often described as a subset of AI, in which an application has the capacity to learn from the past experience. This learning feature usually starts with an initial training phase so as to ensure a minimum level of performance when it is placed into service.

Recently, AI/ML has been introduced and generalized in media related applications, ranging from legacy applications such as image classification, speech/face recognition, to more recent ones such as video quality enhancement. As research into this field matures, more and more complex AI/ML-based applications requiring higher computational processing can be expected, such processing involves dealing with significant amounts of data not only for the inputs and outputs into the AI/ML models, but also for the increasing data size and complexity of the AI/ML models themselves. This growing amount of AI/ML related data, together with a need for supporting processing intensive mobile applications (such as VR, AR/MR, gaming, and more), highlights the importance of handling certain aspects of AI/ML processing by the server over 5G system, in order to meet the required latency requirements of various applications.

The above information is presented as background information only to assist with an understanding of the disclosure. No determination has been made, and no assertion is made, as to whether any of the above might be applicable as prior art with regard to the disclosure.

### SUMMARY

Current implementations of AI/ML are mainly proprietary solutions, enabled via applications without compatibility with other market solutions. In order to support AI/ML for multimedia applications over 5G, AI/ML models should support compatibility between user equipment (UE) devices and application providers from different mobile network operators (MNOs). Not only this, but AI/ML model delivery for AI/ML media services should support media context, UE status, and network status based selection and delivery of the AI/ML model. The processing power of UE devices is also a limitation for AI/ML media services, since next generation media services, such as augmented reality (AR), are typically consumed on lightweight, low processing power devices, such as AR glasses, for which long battery life is also a major design hurdle/limitation.

Aspects of the disclosure are to address at least the above-mentioned problems and/or disadvantages and to provide at least the advantages described below. Accordingly, an aspect of the disclosure is to provide a method and device for efficiently providing an AI/ML media service using AI/ML model split processing in a wireless communication system.

Another aspect of the disclosure is to provide a method and device for extending the current frameworks and architectures for 5G media streaming (5GMS) in order to support AI/ML media services, with several embodiments of different possible architectures, each enabling:

In accordance with an aspect of the disclosure, a method performed by a user equipment (UE) for an artificial intelligence/machine learning (AI/ML) media service in a wireless communication system is provided. The method includes receiving, from a network server providing the AI/ML media service, service access information including at least one of information for media session handling and information for media streaming access, obtaining information on client AI media inferencing capabilities and functions, negotiating with the network server for splitting an AI media inference processing, based on the received service access information and the obtained information on client AI media inferencing capabilities and functions, and receiving, from the network server, either intermediate data or inference output data by AI model split inferencing.

In accordance with another aspect of the disclosure, a UE for an AI/ML media service in a wireless communication system is provided. The UE includes a transceiver, and a processor configured to receive, via the transceiver from a network server providing the AI/ML media service, service access information including at least one of information for media session handling and information for media streaming access, obtain information on client AI media inferencing capabilities and functions, negotiate with the network server for splitting an AI media inference processing, based on the received service access information and the obtained information on client AI media inferencing capabilities and functions, and receive, via the transceiver from the network server, either intermediate data or inference output data by AI model split inferencing.

In accordance with another aspect of the disclosure, a network server for an AI/ML media service in a wireless communication system is provided. the network server includes a transceiver, and a processor configured to transmit, to a UE via the transceiver, service access information including at least one of information for media session handling and information for media streaming access, negotiate with the UE for splitting an AI media inference processing, based on the transmitted service access information, and transmit, to the UE via the transceiver, either intermediate data or inference output data by AI model split inferencing.

In accordance with yet another aspect of the disclosure, one or more non-transitory computer-readable storage media storing one or more computer programs including computer-executable instructions that, when executed by one or more processors of a UE, cause the UE to perform operations, is provided. The operations include receiving, from a network server providing the AI/ML media service, service access information including at least one of information for media session handling and information for media streaming access, obtaining information on client AI media inferencing capabilities and functions, negotiating with the network server for splitting an AI media inference processing, based on the received service access information and the obtained information on client AI media inferencing capabilities and functions, and receiving, from the network server, either intermediate data or inference output data by AI model split inferencing.

The delivery of AI/ML models from the network to the UE for multimedia services.

The selection, configuration, and management of said AI/ML models and their delivery by newly defined network and UE entities, which can consider the 5G network status, cloud/edge AI media inferencing capabilities and functions, UE processing/runtime status and/or capability and functions, and media characteristics, as the input for these decisions related to AI/ML model delivery, and AI/ML model split delivery decisions.

The data and information shared between the network and UE, used for the discovery of capabilities and functions, as well as the negotiation and configuration of the split AI media inference process. Such information may include information related to network and/or UE processing capabilities, and/or information describing/or originating from the characteristics of the AI model to be delivered and used for the AI/ML media service.

On successful capability/function discovery, as well as negotiation for the split configuration, the delivery of the AI model may occur in a progressive download manner, where the AI model data is divided into independently deliverable and inference-able subsets in advance. This delivery mechanism may allow for: simultaneous inferencing to start before the complete download of the AI model data, dynamic configuration of split inferencing without further data delivery (since the UE already receives the whole AI model), and efficient partial updates of the AI model during the AI media service (since certain parts for update can be easily identified and replaced, using the granularity of the AI model data subset).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows an embodiment of an overall 5G media streaming (5GMS) architecture in a wireless communication system according to an embodiment of the disclosure;

FIG. 2 shows an embodiment of a 5GMS general architecture in a wireless communication system according to an embodiment of the disclosure;

FIG. 3 shows an embodiment of a high level procedure for media downlink streaming in a wireless communication system according to an embodiment of the disclosure;

FIG. 4 shows an embodiment of a baseline procedure describing an establishment of a unicast media downlink streaming session in a wireless communication system according to an embodiment of the disclosure;

FIG. 5 shows an embodiment of an AI/ML media service scenario according to an embodiment of the disclosure;

FIG. 6 shows an embodiment of an AI/ML media service scenario according to an embodiment of the disclosure;

FIG. 7 shows an embodiment of an AI/ML media service scenario according to an embodiment of the disclosure;

FIG. 8 shows an embodiment of a basic architecture for a split AI inferencing scenario according to an embodiment of the disclosure;

FIG. 9 shows an embodiment of another basic architecture for a split AI inferencing scenario according to an embodiment of the disclosure;

FIG. 10 shows an embodiment of an AI/ML architecture instantiation for 5G Media Streaming according to an embodiment of the disclosure;

FIG. 11 shows an embodiment of a procedure for the management of the AI split inference in a wireless communication system according to an embodiment of the disclosure; and

FIG. 12 illustrates an example of a configuration of a network entity in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “ . . . unit” means a software element or a hardware element. The “ . . . unit” plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub-units. Further, an element or a ‘unit’ may be implemented to reproduce one or more central processing units (CPUs) in a device or a security multimedia card. According to embodiments, a “ . . . unit” may include one or more processors.

As used herein, each of such phrases as “A and/or B”, “A or B”, “at least one of A and B”, “at least one of A or B”, “A, B, or C”, “at least one of A, B, and C”, and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

In the disclosure, the user equipment (UE) may refer to a terminal, mobile station (MS), cellular phone, smartphone, computer, or various electronic devices capable of performing communication functions. According to the disclosure, the base station (BS) may be an entity allocating a resource to the UE and may be at least one of a gNode B, gNB, eNode B, eNB, Node B, BS, radio access network (RAN), base station controller, or node on network.

The embodiments of the disclosure may also apply to other communication systems with similar technical background or channel form. Further, embodiments of the disclosure may be modified in such a range as not to significantly depart from the scope of the disclosure under the determination by one of ordinary skill in the art and such modifications may be applicable to other communication systems.

In a specific description of the disclosure, a communication system may use various wired or wireless communication systems, e.g., the new RAN (NR), which is the radio access network, and the packet core (5G system, or 5G core network, or next generation core (NG core)), which is the core network, according to the 5G communication standard of the 3GPP which is a radio communication standardization organization. Embodiments of the disclosure may also be applicable to communication systems with a similar technical background with minor changes without significantly departing from the scope of the disclosure, and this may be possible under the determination of those skilled in the art to which the disclosure pertains.

As used herein, terms for identifying access nodes, terms denoting network entities (NEs), terms denoting messages, terms denoting interfaces between network functions (NFs), and terms denoting various pieces of identification information are provided as an example for ease of description. Thus, the disclosure is not limited by the terms, and such terms may be replaced with other terms denoting objects with equivalent technical concept.

The 5G system may support the network slice, and traffic for different network slices may be processed by different protocol data unit (PDU) sessions. The PDU session may mean an association between a data network providing a PDU connection service and a UE. The network slice may be understood as technology for logically configuring a network with a set of network functions (NF) to support various services with different characteristics, such as broadband communication services, massive IoT, V2X, or other mission critical services, and separating different network slices. Therefore, even when a communication failure occurs in one network slice, communication in other network slices is not affected, so that it is possible to provide a stable communication service. In the disclosure, the term “slice” may be interchangeably used interchangeably with “network slice.” In such a network environment, the UE may access a plurality of network slices when receiving various services. Further, the network function (NF) may be a software instance running on hardware and be implemented as a virtualized function instantiated on a network element or an appropriate platform.

The mobile communication provider may constitute the network slice and may allocate network resources suitable for a specific service for each network slice or for each set of network slices. A network resource may mean an network function (NF) or logical resource provided by the NF or radio resource allocation of a base station.

For example, a mobile communication provider may configure network slice A for providing a mobile broadband service, network slice B for providing a vehicle communication service, and network slice C for providing a broadcast service. In other words, the 5G network may efficiently provide a corresponding service to a UE through a specialized network slice suited for the characteristics of each service. In the 5G system, the network slice may be represented as single-network slice selection assistance information (S-NSSAI). The S-NSSAI may include a slice/service type (SST) value and a slice differentiator (SD) value. The SST may indicate the characteristics of the service supported by the network slice (e.g., enhanced mobile broadband (eMBB), IoT, ultra-reliability low latency communication (URLLC), V2X, etc.). The SD may be a value used as an additional identifier for a specific service referred to as SST.

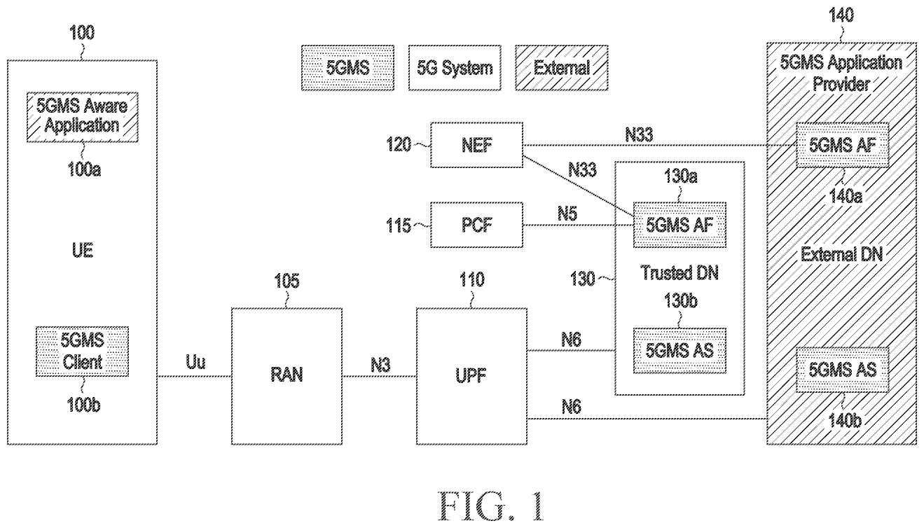

In the disclosure, the network technology may refer to the standards (e.g., TS 23.501, TS 23.502, TS 23.503, etc.) defined by the international telecommunication union (ITU) or 3GPP, and each of the components included in the network architecture of FIG. 1 may mean a physical entity or may mean software that performs an individual function or hardware combined with software. Reference characters denoted by Nx in the drawings, such as N1, N2, N3, . . . , etc., indicate known interfaces between NFs in the 5G core network (CN), and the relevant descriptions may be found in the standard specifications (TS 23.501). Therefore, a detailed description will be omitted.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

FIG. 1 shows an embodiment of an overall 5G media streaming (5GMS) architecture in a wireless communication system according to an embodiment of the disclosure. FIG. 1 represents the specified 5GMS functions within the 5GS as defined TS 23.501.

Referring to FIG. 1, 5GMS System may be an assembly of application functions, application servers and interfaces from the 5G Media Streaming architecture that support either downlink media streaming services or uplink media streaming services, or both. The components of a 5GMS System may be provided by an MNO as part of a 5GS and/or by a 5GMS application provider 140. The 5GMS application provider 140 may be a party that interacts with functions of the 5GMS System and supplies a 5GMS-aware application 100a of an UE 100 that interacts with functions of the 5GMS System.

The 5GMS-aware application 100a may be an application in the UE 100, provided by the 5GMS application provider 140, that contains the service logic of the 5GMS application service, and interacts with other 5GMS client 100b and network functions via the interfaces and application programming interfaces (APIs) defined in the 5GMS architecture. The 5GMS-aware application 100a associated with the delivery of a downlink related 5GMS service may be referred to as a 5GMSd-aware application. 5GMS client 100b in the UE 100 may include a 5G media streaming client for downlink (5GMSd) client. The 5GMSd client may be a UE function that includes at least a 5G media streaming player and a media Session handler for downlink streaming and that may be accessed through well-defined interfaces/APIs.

The 5GMS application provider 140 uses 5GMS for streaming services. The 5GMS application provider 140 provides a 5GMS aware-application 100a on the UE 100 to make use of 5GMS client 100b and network functions using interfaces and APIs defined in 5GMS. 5GMS AF 130a, 140a may be an application function similar to that defined in TS 23.501 clause 6.2.10, dedicated to 5G media streaming. 5GMS AS 130b, 140b may be an application server dedicated to 5G media streaming. 5GMS client 100b may be a UE internal function dedicated to 5G media streaming. The 5GMS client 100b is a logical function and its subfunctions may be distributed within the UE according to implementation choice. 5GMS AF 130a, 140a and 5GMS AS 130b, 140b are data network (DN) functions and communicate with the UE 100 via N6 as defined in TS 23.501.

Functions in trusted DNs 130, e.g., a 5GMS AF 130a in the trusted DN 130, are trusted by the operator's network Therefore, the 5GMS AF 130a may directly communicate with the relevant 5G Core functions. Functions in external DNs 140, e.g., a 5GMSvant 140a in the external DN 140, may only communicate with 5G core functions via network exposure function (NEF) 120 using N33. The NEF 120 may be responsible for transmitting or receiving an event occurring in the 5G system and a supported capability to/from the outside.

The RAN 101 may be a base station (e.g., gNB or integrated access and backhaul (IAB)) supporting radio access technology in the 5G system. The radio access network (RAN) 105 may deliver control information and/or data from the 5GMS application provider 140 to the UE 100 through a core network (i.e., 5GC). A user plane function (UPF) 110 serves to process data of the UE 100 and may play a role to transfer data transmitted from the UE 100 or process data to allow data introduced from the 5GMS AF/AS to be transferred to the UE 100. The UPF 110 may perform network functions, such as acting as an anchor between radio access technologies (RATs), providing connection with PDU sessions and the 5GMS AF/AS, packet routing and forwarding, packet inspection, application of user plane policy, creating a traffic usage report, or buffering. A policy control function (PCF) 115 is an NF that manages operator policy information for providing a service in the 5G system.

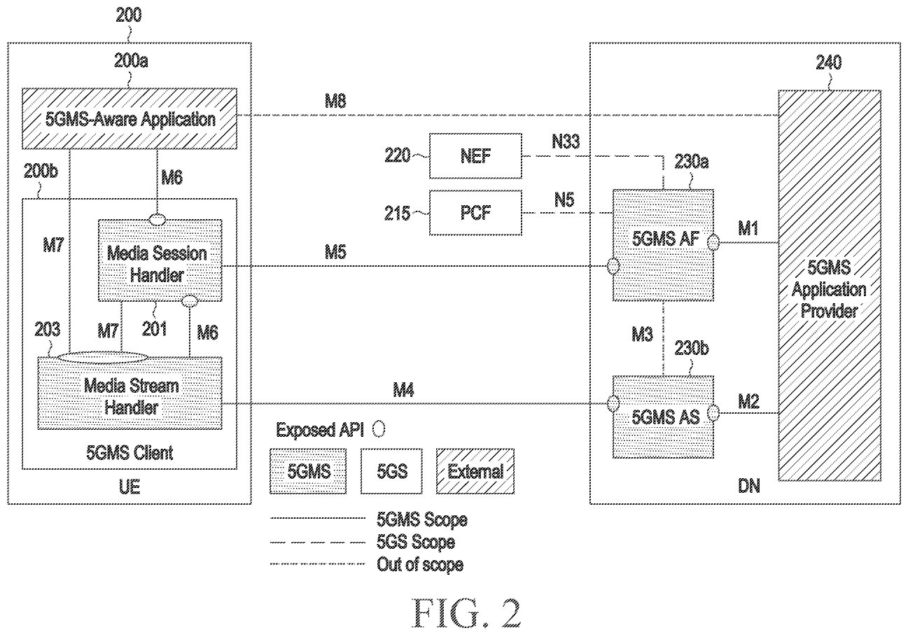

FIG. 2 shows an embodiment of a 5GMS general architecture in a wireless communication system according to an embodiment of the disclosure. FIG. 2 represents media streaming functional entities and interfaces are specified within the disclosure.

Referring to FIG. 2, system exemplified in FIG. 2 may include a UE 200, a data network (DN), NEF 220, and PCF 215, etc. The UE 200 include 5GMS-aware application 200a and 5GMS client 200b, and The DN include 5GMS AF 230a, 5GMS AS 230b and 5GMS application provider 240. Since the basic functions of NFs/network entities shown in FIG. 2 are the same as those of the corresponding NFs/network entities shown in FIG. 1, detailed descriptions thereof will be omitted. The 5GMS client 200b may include a media session handler 201 and a media stream handler 203. The 5GMS client 200b in the UE 200 is depicted in the form of media session handler 201 and media stream handler 203 constituent functions which expose APIs to one another in the same way that those APIs are exposed to 5GMS-aware application(s) 200a. The media session handler 201 may communicates with the 5GMS AF 230a in order to establish and control the delivery of a media streaming session, and which also exposes APIs to the 5GMS-aware application 200a. The media streaming session denotes a session initiated by a 5GMS-aware application 200a that involves one or more media streams being delivered between the 5GMShat 230b and the 5GMS client 200b via reference point M4.

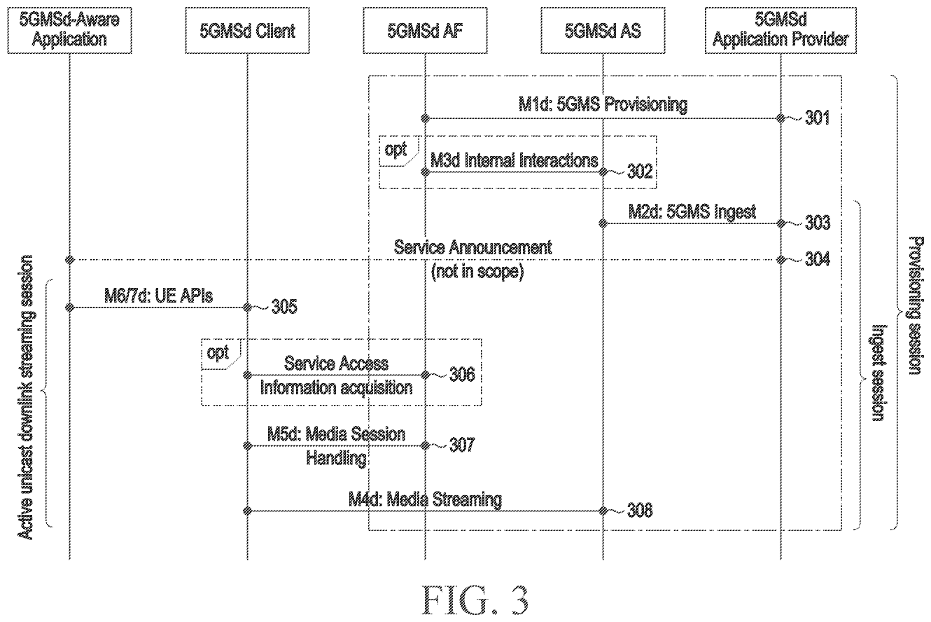

FIG. 3 shows an embodiment of a high level procedure for media downlink streaming in a wireless communication system according to an embodiment of the disclosure. Since the basic functions of NFs/network entities shown in FIG. 3 are the same as those of the corresponding NFs/network entities shown in the above FIGS. 1 and/or 2, detailed descriptions thereof will be omitted.

Referring to FIG. 3, an ingest session refers to a time interval during which media content is uploaded to the 5GMSd AS. A provisioning session refers to a time interval during which the 5GMSd client may access media content and the 5GMSd application provider may control and monitor the media content and its delivery. Interactions between the 5GMSd AF and the 5GMSd application provider may occur at any time while the provisioning session is active. The 5GMSd provisioning API at M1d allows selection of media session handling (M5d) and media streaming (M4d) options, including whether the media content is hosted on trusted 5GMSd AS instances.

Referring to FIG. 3, operation 301: The 5GMSd application provider creates the provisioning session with the 5GMSd AF and starts provisioning an usage of the 5G media streaming system. During the establishment phase, the used features may be negotiated and detailed configurations be exchanged. The 5GMSd AF receives service access information for M5d (media session handling) and, where media content hosting is negotiated, service access information for M2d (Ingestion) and M4d (Media Streaming) as well. This information is needed by the 5GMSd client to access the service. Depending on the provisioning, a reference to the service access information may be supplied.

Operation 302: (Optional) When content hosting is offered and selected there may be interactions between the 5GMSd AF and the 5GMSd AS, e.g., to allocate 5GMSd content ingest and distribution resources. The 5GMSd AS provides resource identifiers for the allocated resources to the 5GMSd AF, which then provides the information to the 5GMSd application provider.

Operation 303: The 5GMSd application provider starts the ingest session by ingesting content. In case of live services, the content is continuously ingested. In case of on-demand streaming services, the content may be uploaded once and then updated later on. A 5GMSd AS in the external DN may provide the content hosting.

Operation 304: The 5GMSd application provider provides the service announcement information to the 5GMSd-aware application. The service announcement information includes either whole service access information (i.e., details for media session handling (M5d) and for media streaming access (M4d)) or a reference to the service access information or pre-configured information. When only a reference is included, the 5GMSd client fetches (in below operation 306) the services access information when needed.

Operation 305: When the 5GMSd-aware application decides to begin streaming, the service access information (all or a reference) is provided to the 5GMSd client. The 5GMSd client activates the unicast downlink streaming session.

Operation 306: (Optional) In case the 5GMSd client received only a reference to the service access information, then the 5GMSd client acquires the service access information from the 5GMSd AF. Pre-caching of service access information may also be supported by the 5GMS client to speed up the activation of the service.

Operation 307: The 5GMSd client uses the media session handling API exposed by the 5GMSd AF at M5d. The media session handling API is used for configuring content consumption measurement, logging, collection and reporting; configuring quality of experience (QoE) metrics measurement, logging, collection and reporting; requesting different policy and charging treatments; or 5GMSd AF-based network assistance. The actual time of API usage depends on a feature and interactions that may be used during the media content reception.

Operation 308: The 5GMSd client activates reception of the media content.

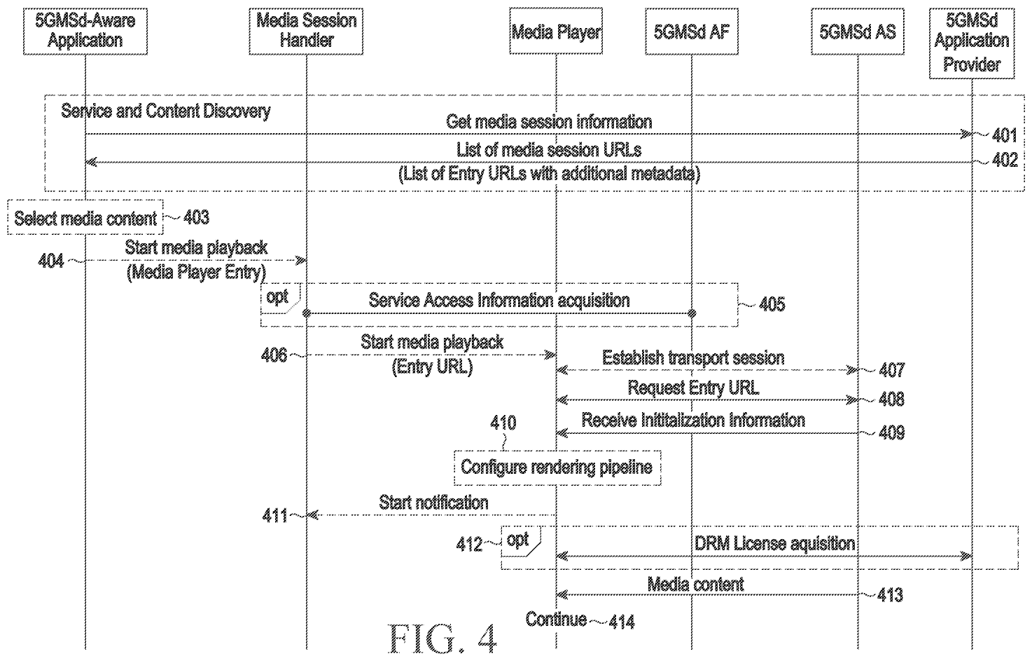

FIG. 4 shows an embodiment of a baseline procedure describing an establishment of a unicast media downlink streaming session in a wireless communication system according to an embodiment of the disclosure.

Since the basic functions of NFs/network entities shown in FIG. 4 are the same as those of the corresponding NFs/network entities shown in the above FIGS. 1 and/or 2, detailed descriptions thereof will be omitted. The baseline procedure assumes that the 5GMSd AF and the 5GMSd AS both reside in the external DN. Also, the baseline procedure assumes that 5GMSd application provider has provisioned the 5GMS system and has set up content ingest and 5GMSd-aware application has received the service announcement information from the 5GMSd application provider.

Referring to FIG. 4, operations 401, 402: the 5GMSd-aware application triggers service announcement and service and content discovery procedure. The service announcement information includes either whole service access information (i.e., details for media session handling (M5d) and for media streaming access (M4d)) or a reference to the service access information.

Operation 403: A media player entry is selected.

Operation 404: The 5GMSd-aware application triggers the media session handler to start the playback. The media player entry is provided to the media session handler.

Operation 405: (Optional) When the 5GMS-aware application has received a reference to the service access information, the media session handler interacts with the 5GMSd AF to acquire the whole service access information.

Operation 406: The media session handler triggers the media player to start the session.

Operation 407: The media player establishes the transport session. The UE may include the (5GMSd) media player that enables playback and rendering of a media presentation based on a media player entry and exposing some basic controls such as play, pause, seek, stop to the 5GMSd-aware application.

Operation 408: The media player sends a request for progressive download content.

Operation 409: The media player receives initialization information of the progressive download content. The initialization information includes configuration parameters for reception of the media and, optionally, also digital rights management (DRM) information.

Operation 410: The media player configures the rendering pipeline for media playback.

Operation 411: The media player notifies the media session handler, providing the transport session information and some media content related information.

Operation 412: (Optional) The media player acquires a DRM license from the 5GMSd application provider.

Operation 413: The media player receives media content and puts the media content into the rendering pipeline.

Operation 414: The media player continuously receives and plays back the media content.

FIG. 5 shows an embodiment of a simple AI/ML media service scenario where an AI/ML model is required to be delivered from the network to the UE (end device) according to an embodiment of the disclosure.

Referring to FIG. 5, AI/ML model is delivered (501) from a network server 520 to the UE (end device) 510. Upon receiving the AI model, the UE (end device) 510 performs the inferencing of the AI model, feeding the relevant media as an input into the AI model.

In FIG. 5, a typical example:

John is in Seoul for his summer vacation, and he is in Jamsil wanting to visit Lotte Tower for sightseeing. John cannot read Korean, and finds it difficult to navigate his way to Lotte Tower.

John takes out his mobile phone (UE) 510, and opens an augmented reality navigation service on it. His network operator provides the service via 5G system, and through the analysis of different information, a suitable AI model is delivered (501) to the UE 510. Such information includes information available from the network, such as John's UE's location, his charging policy, network availability and conditions (bandwidth, latency) etc., his UE's processing capabilities and status, as well as the media properties which will be used as the input to the AI model.

Once the AI model is delivered (501) to the UE 510, the AR navigation service initiates the camera on the phone to capture the John's surroundings.

The captured video from the phone's camera is fed as the input into the AI model, and the AI model inferencing is initiated.

The output of the AI model may provide direction labels (such as navigation arrows) which are shown as overlays in the phone's screen live camera in order to guide John to Lotte Tower. Road signs in Korean may be also overlayed by English labels output from the AI model.

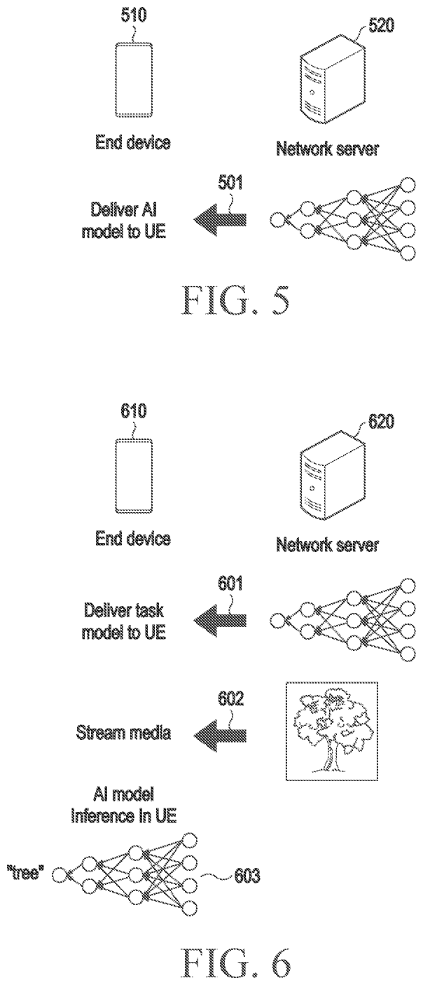

FIG. 6 shows an embodiment of a scenario where an AI model is delivered to the UE, and also where media (such as video) is also streamed to the UE (end device) according to an embodiment of the disclosure. In the UE, the streamed video is fed as an input into the received AI model for processing.

Referring to FIG. 6, an AI model is delivered (601) from a network server 620 to the UE (end device) 610, and also where media (such as video) is also streamed (602) to the UE 610. In the UE 610, the streamed video is fed as an input into the received AI model for processing.

The AI model may perform any media related processing, for example: video upscaling, video quality enhancement, vision applications such as object recognition (e.g., “tree” recognition as in an example of FIG. 6), facial recognition, etc.

A simple description of the required operations is at least one of:
Service provisioning and announcement of AI media service;
Service access information acquisition;
Including possible request/subscription of AI model by UE or network (which task UE wants to perform, takes into account media requirements, network status parameters, UE status parameters, network or UE selects suitable AI model), building or ingesting an adapted model if not already available, and model selection;
Requesting the start of the AI data/media delivery; or
Delivering the AI data (and possibly media data) for AI media inferencing includes at least one of:
Session(s) establishment(s);
Delivery of AI model from network to UE;
Configure media session downlink;
Stream media from network; or
AI media inference (603) in UE.

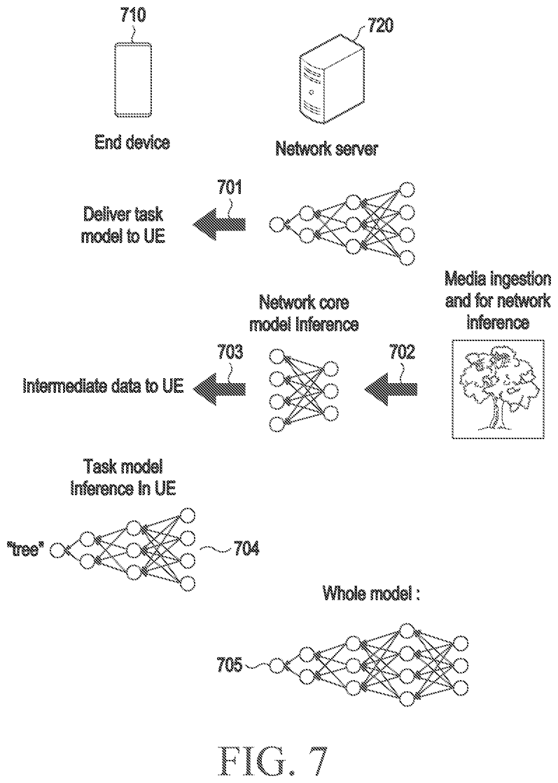

FIG. 7 shows an embodiment of a scenario where the inferencing required for the AI media service is split between the network and UE (end device) according to an embodiment of the disclosure.

Referring to FIG. 7, a portion of the AI model to be inferenced on the UE 710 is delivered (701) from a network server 720 to the UE (end device) 710. Another portion of the AI model to be inferenced in the network server 720 is provisioned by the network server 720 to an entity which performs the inferencing in the network server 720. The media for inferencing is firstly provisioned and ingested (702) by the network server 720 to the network inferencing entity, when feeds the media as an input into the network portion of the AI model. The output of the network side inference (intermediate data) is (703) then sent to the UE 710, which received this intermediate data and feeds it as an input into the UE side portion 704 of the AI model, hence completing the inference of the whole model 705.

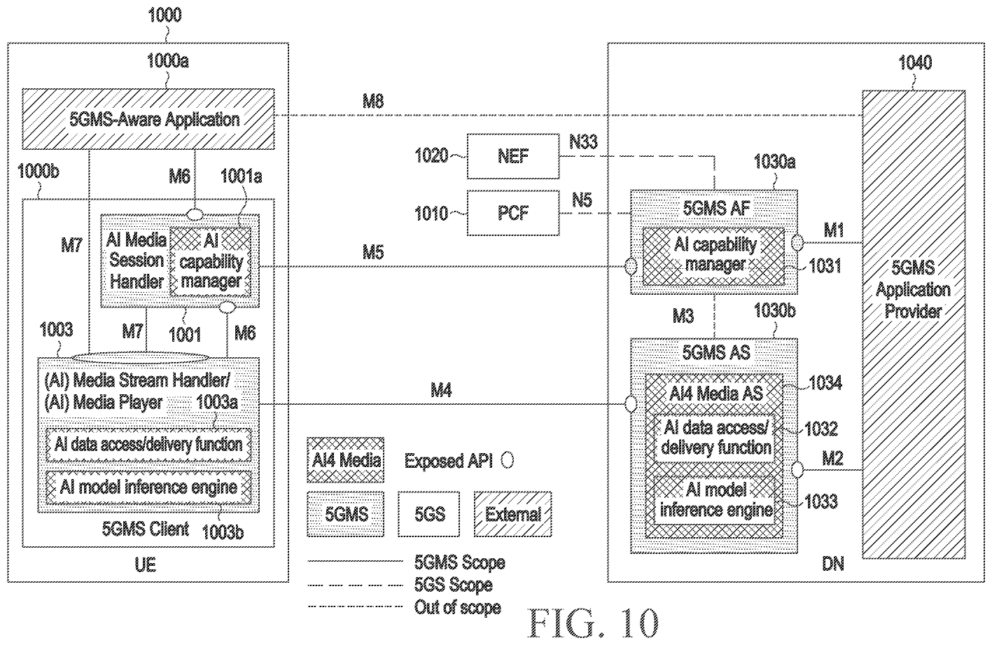

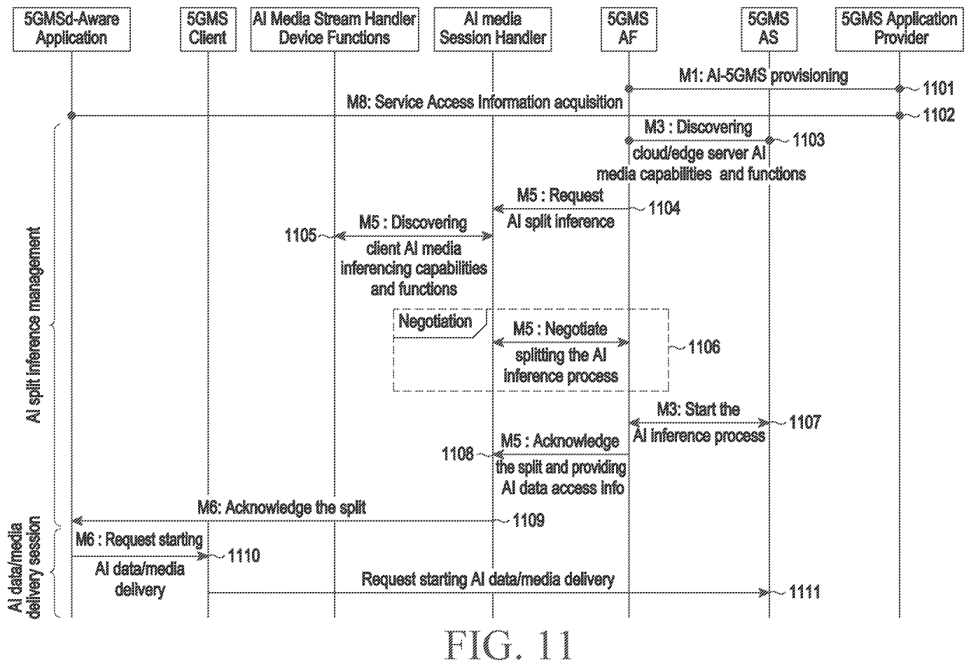

In this scenario, the split decision and configuration is negotiated between the UE 710 and the network server 720, and a simple description of the required operations includes (details will be given in embodiments of FIGS. 10 and 11 to be described later) at least one of:
Service provisioning and announcement of AI media service;
Service access information acquisition;
Including possible request/subscription of AI model by UE or network server (which task UE wants to perform, takes into account media requirements, network status parameters, UE status parameters, network or UE selects suitable AI model), building or ingesting an adapted model if not already available, and model selection;
Discovering cloud/edge AI media inferencing capabilities and functions;
Requesting AI split inferencing, either by the network server or the UE, for an AI split inference service;
Discovering client AI media inferencing capabilities and functions;
Negotiating splitting the AI media inference process;
Starting the inference process in the network server;
Acknowledging the split and providing the AI data split inferencing access information;
Acknowledging the split configuration;
Requesting the start of the AI data/media delivery; or
Delivering the AI data (and possibly media data) for AI media inferencing includes at least one of:
Session(s) establishment(s);
Delivery of split AI model from network server to UE;
Configure media session downlink;
Stream media from network; or
AI media inference in UE.

In one split configuration example of FIG. 7, an AI model service may consist of a core portion, as well as a task specific portion (e.g., traffic sign recognition task, or facial recognition task), where the core portion of the AI model is common to multiple possible tasks. In this case, the split configuration may coincide the core and task portions in a manner such that the network (server) performs the inference of the core portion of the AI model, and the UE (receives and) performs the inference of the task portion of the model.

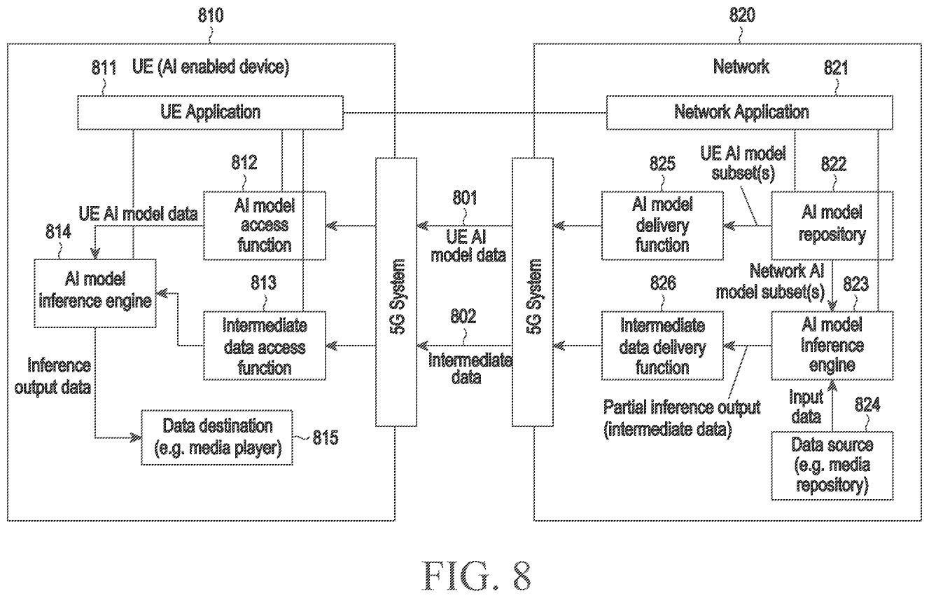

FIG. 8 shows an embodiment of a basic architecture for a split AI inferencing scenario according to an embodiment of the disclosure, where the media source originates from the network, and as such, where the split inferencing occurs first in the network, then subsequently in the UE. This architecture shows logical functions related to user plane data, in particular AI data.

Referring to FIG. 8, the UE 810 may include at least one of a UE application 811, AI model access function 812, intermediate data access function 813, AI model inference engine 814, and data destination (e.g., media player) 815. The network (e.g., including one or more network servers) 820 may include at least one of network application 821, AI model repository 822, AI model inference engine 823, data source (e.g., media repository) 824, AI model delivery function 825, and intermediate data delivery function 826. The AI model inference engine 814 may receive UE AI model data 801 which corresponds to UE AI model subset(s) from the network 820, receive intermediate data which corresponds to partial inference output by AI model inference engine 823 using network AI model subset(s) in the network 820, and then inference output data, which is the output of an AI inference process, based on the UE AI model data 801 and the intermediate data.

In FIG. 8, AI data may include at least one of:
AI model data (i.e., the data related to the structure of the AI model, including the number of layers, the weights and biases for the nodes and links between the layers, etc.), the AI model data may include network AI model subset(s) and UE AI model subset(s) in the disclosure. The UE AI model subset(s) corresponding to UE AI model data 801 may be delivered from the network 820 to the UE 810;
Intermediate data 802, which is the output of a first split inference, typically required to be delivered to a second device or entity (e.g., UE 810), as the input to a subsequent second split inference. Intermediate data 802 may have media characteristics; or
Inference output data, which is the output of an AI inference process. Depending on the nature of the AI media inferencing for the given Ai media service, this inference output data may include: at least one of label(s) for identifying recognition like tasks from media, actual media data such as video and/or audio, XR related data such as 3D models or any other possible inference output.

In FIG. 8, an AI model repository 822 in the network 820 provides corresponding network AI model subset(s) and UE AI model subset(s) to the network 820 (to the network AI model inference engine 823) and UE 810 (via the AI model delivery function 825, 5G system, UE AI model access function 812, to the UE AI model inference engine 814) respectively.

On network split inferencing by the network AI model inference engine 823, the output intermediate data 802 is delivered to the UE 810 as the input to the UE AI model inference engine 814 (via the intermediate data delivery and access functions 826, 813). The final inference output data is then consumed within the UE 810 at the data destination 815.

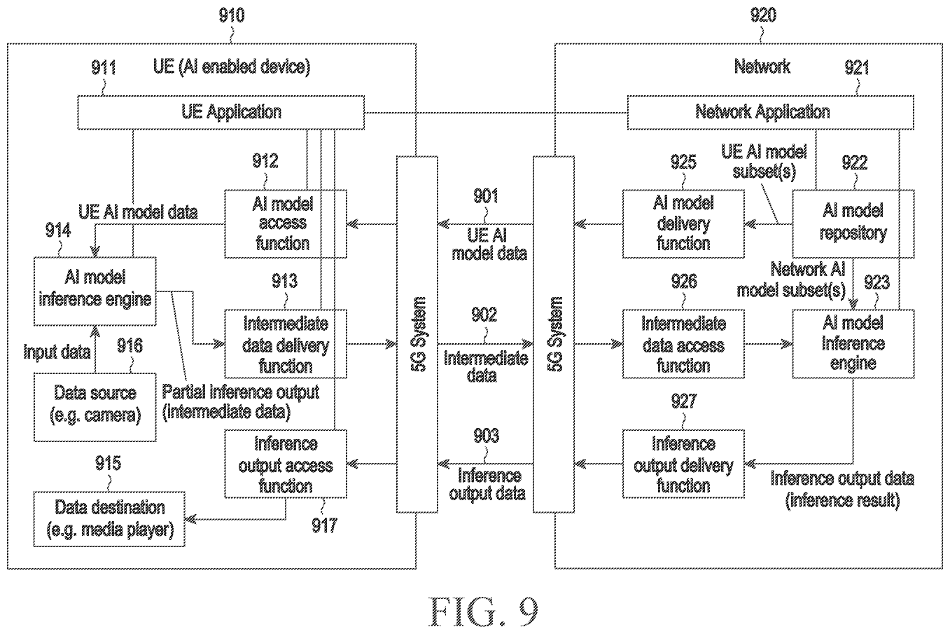

FIG. 9 shows an embodiment of another basic architecture for a split AI inferencing scenario according to an embodiment of the disclosure, where the media source originates in the UE 910, and as such, where the split inferencing occurs first in the UE 910, then subsequently in the UE 910. Typically after the final inference in the network 920, the inference output data is then also sent to the UE 910 for consumption. This architecture shows logical functions related to user plane data, in particular AI data. The logical user plane functions in FIG. 9 may have similar functionality to those described in FIG. 8.

Referring to FIG. 9, the UE 910 may include at least one of a UE application 911, AI model access function 912, intermediate data delivery function 913, inference output access function 917, AI model inference engine 914, data source (e.g., camera) 916, and data destination (e.g., media player) 915. The network (e.g., including one or more network servers) 920 may include at least one of network application 921, AI model repository 922, AI model inference engine 923, AI model delivery function 925, intermediate data access function 926, and an inference output delivery function 927. The AI model inference engine 923 in the network 920 may receive intermediate data 902 which corresponds to partial inference output by AI model inference engine 914 using UE AI model subset(s) in the UE 910, and output inference output data 903, which is the output of an AI inference process, based on network AI model subset(s) and the received intermediate data 902. The inference output data 903 is output by the inference output delivery function 927 and delivered to the UE 910.

In FIG. 9, AI data may include at least one of:
AI model data (i.e., the data related to the structure of the AI model, or AI model topology information, including the number of layers, the weights and biases for the nodes and links between the layers, etc.), the AI model data may include network AI model subset(s) and UE AI model subset(s) in the disclosure. The UE AI model subset(s) corresponding to UE AI model data 901 may be delivered from the network 920 to the UE 910;
Intermediate data 902, which is the output of a first split inference, typically required to be delivered to a second device or entity (e.g., network 920), as the input to a subsequent second split inference. Intermediate data 902 may have media characteristics; or
Inference output data 903, which is the output of an AI inference process. Depending on the nature of the AI media inferencing for the given Ai media service, this inference output data may include: at least one of label(s) for identifying recognition like tasks from media, actual media data such as video and/or audio, XR related data such as 3D models or any other possible inference output.

FIG. 10 shows an embodiment of an AI/ML architecture instantiation for 5G Media Streaming according to an embodiment of the disclosure. The basic functions of NFs/network entities shown in FIG. 10 may have similar functionality to those described in FIGS. 1 and/or 2.

Referring to FIG. 10, UE 1000 may include 5GMS-aware application 1000a and 5GMS client 1000b. The 5GMS client 1000b may include an AI media session handler 1001 and an AI media stream handler/media player 1003. Furthermore, the AI media session handler 1001 may include AI capability manager 1001a, and the AI media stream handler/media player 1003 may include an AI data access/delivery function 1003a and AI model inference engine 1003b. The network (DN) may include 5GMS AF 1030a, 5GMS AS 1030b, and 5GMS application provider 1040. Furthermore, the 5GMS AF 1030a may include AI capability manager 1031, and the 5GMS AS 1030b, including AI4 media AS 1034, may include an AI data access/delivery function 1032 and AI model inference engine 1033. The 5GMS AF 1030a may be commutatively connected to NEF 1020 and PCF 1010.

The AI capability manager 1001a, the AI data access/delivery function 1003a and the AI model inference engine 1003b correspond to logical functions at a UE side related to AI/ML, and the AI capability manager 1031, the AI data access/delivery function 1032 and the AI model inference engine 1033 correspond to logical functions at a network side related to AI/ML as described in FIGS. 8 and 9, more specifically at least one of:
AI data access/delivery functions 1003a, 1032 in both the UE and the network, to delivery and receive AI data (including the above AI model data, intermediate data, inference result data etc.);
AI model inference engine functions 1003b, 1033 in both the UE and the network, for inferencing either the whole, or partial (split) AI model; or
AI media capability manager functions 1001a, 1031 in both the UE and the network, which discover the AI media inference capabilities and functions of the UE and network, respectively, as well as handles the negotiation of the splitting for the split AI media inference process. The AI media capability manager functions 1001a, 1031 in the UE and network may have AI information related reporting and collection functionalities.

Depending on the exact delivery mechanism used to deliver AI model data, the sender side AI data access/delivery function 1003a or 1032 may also contain additional specific functionalities, such as at least one of:
Building and ingesting an adapted AI model for a particular AI media service;
Splitting the AI model structure into multiple separate parts, or subsets, such that the separate parts may or may not be inference-able separately (e.g., splitting a 10 layer AI model into 5 different subsets, each subset containing 2 layers); or
Packetizing multiple AI model subsets such that they can be delivered, received, and inferenced independently.

FIG. 11 shows an embodiment of a procedure for the management of the AI split inference in a wireless communication system according to an embodiment of the disclosure.

Functions of NFs/network entities shown in FIG. 11 are the same as those of the corresponding NFs/network entities shown in the above FIG. 10, detailed descriptions thereof will be omitted. At least one of 5GMSd-aware application, 5GMS client, AI media stream handler device function(s), and AI media session handler shown in FIG. 11 may be included in the UE. At least one of 5GMS AF, 5GMS AS, and 5GMS application provider may be included in one or more network servers at a network side.

Referring to FIG. 11, operation 1101: Service provisioning and announcement of AI media service on the network side is performed, in particular between the 5GMS AF (application function) and the 5GMS application provider.

Operation 1102: 5GMS-aware application may obtain service access information (i.e., details for media session handling (M5d) and for media streaming access (M4d)) or a reference to the service access information, based on service announcement information received the 5GMS application provider.

During the operation 1102, the available or required AI model(s) for the service can be made known to the UE, by means of information made available via a URL link pointing to a file or manifest which may last such available AI models.

The received information in the operation 1102 may already include AI model specific information, such as: the size of the AI model network, including the number of layers contained in the AI model structure, the number of nodes and links in each layer, the complexity of each layer in the AI model (i.e., the number of free parameters), the possible split points for the AI model for split inferencing, and also the AI model target inference delay.

Additional operations here may include also include those for AI model request/subscribe by the UE, building and/or ingesting an adapted model by the network if not available, and possible model selection by either the UE or the network server, based on factors such as policy, charging, service type, UE/network capability, etc.

Operation 1103: Discovering cloud/edge AI media inferencing capabilities and functions may be performed between 5GMS AF and 5GMS AS.

In the operation 1103, the 5GMS AF, namely the AI capability manger function, may use its capabilities to calculate the range of service side inference latencies for the AI model to be used for the AI media service.

Operation 1104: Requesting AI split inference may be performed between AI media session handler and 5GMS AF.

In operation 1104, either the UE or the network server may request the other side for the above described AI split inference service according to the disclosure. If Information describing the AI model was not made known via the service access information in the operation 1102, then such information may be also shared during operation 1103 (e.g., at least one of the same of the size of the AI model network, including the number of layers contained in the AI model structure, the number of nodes and links in each layer, the complexity of each layer in the AI model (i.e., the number of free parameters), the possible split points for the model for split inferencing, and also the AI model target inference delay may be shared).

Operation 1105: Discovering client AI media inferencing capabilities and functions may be performed between the AI media stream handler device function(s) and the AI media session handler. The AI media session handler may include a AI capability manager.

The AI capability manager in the UE device may use the AI model information received, as well as device capability information, to calculate the UE inference latencies for the split configurations.

Operation 1106: Negotiation for splitting the AI media inference process may be performed between the AI media session handler and the 5GMS AF.

The information obtained/processed in operations 1103, 1104 and 1105 may be exchanged between the UE and the network server through the M5 interface (for control plane data), such that a split point may be selected to satisfy the following Equation 1:

$$UE side split inference latency + network side split inference latency + AI data network delay ( intermediate date and / or inference result date ) \leq AI model target inference delay \qquad Equation 1$$

One embodiment for the specific negotiation procedure may include the sending of the calculated UE side split inference latencies by the UE to the network server (from/to the AI capability manager), after which the network sever decides the split inference point using such information (which satisfies the total AI model target inference delay).

Another embodiment for the specific negotiation procedure may include the sending of the network side inference latencies by the network to the UE, after which the UE device decides the split inference point using such information (which satisfies the total AI model target inference delay).

Operation 1107: Start inference process in the network server.

In operation 1107, the 5GMS AF may trigger the inference process in the 5GMS AS (using the AI inference engine function), namely the network side of the AI model split inferencing as decided by the result of operation 1106.

Operation 1108: Acknowledgement the AI model split and providing the AI data split inferencing access information may be performed between the network server and the UE.

In operation 1108, the network server (5GMS AF) and UE (AI media session handler) both may acknowledge the decided split point, and access information for the AI data may be provided to the UE.

Operation 1109: Acknowledgement of the AI model split.
the split management outcome may be notified from the AI media session handler to the 5GMS-aware application.

Operation 1110: Request for the start of AI data/media delivery (UE internal).

On confirmation, the 5GMSd-aware application may trigger the 5GMS client to request the start of AI data delivery using the AI data split inferencing access information provided in operation 1108.

Operation 1111: Request for the start of AI data/media delivery (UE to network).

The UE 5GMS client may request the AI data to be delivered from the 5GMS AS.

NOTE: in embodiments of this disclosure where media data is also delivered between the network server and the UE, such procedures for media delivery may occur before, during, or after the operations 1110 and/or 1111. It is also noted that such conventional procedures are specified in TS 26.501, although embodiments may also include (embed) the conventional procedures as part of the procedures for AI data provisioning, discovery, negotiation and delivery request as in FIG. 11 (i.e., one set of procedures for provision, discover, negotiation and delivery request are used for both AI data and media data).

In such a manner, there may be two sets of procedures, one for AI data, one for media data (the ordering of which can be interchangeable), and there may also be only one set of procedures, used for both AI data and media data simultaneously.

The following is enabled by the disclosure: network capability/function/status, UE capability/function/status and multimedia context driven AI/ML model selection and AI/ML model split inference decision/negotiation, delivery and management between a network server and UE for AI multimedia services.

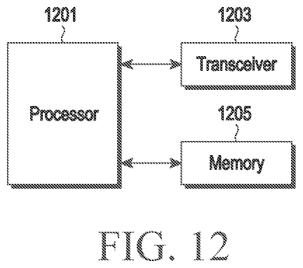

FIG. 12 illustrates an example of a configuration of a network entity in a wireless communication system according to an embodiment of the disclosure.

The network entity of FIG. 12 may be one of the UE, the network functions (NFs), or the network sever described above in connection with FIGS. 1 to 11.

According to an embodiment of the disclosure, the network entity may include a processor 1201 controlling the overall operation of the network entity according to one or a combination of two or more of embodiments of FIGS. 1 to 11, a transceiver 1203 including a transmitter and a receiver, and a memory 1205. Without limited thereto, the network entity may include more or less components than those shown in FIG. 12.

According to an embodiment of the disclosure, the transceiver 1203 may transmit/receive signals to/from at least one of other network entities or the UE. In addition, the transceiver 1203 may include a communication interface for wiredly/wirelessly transmitting/receiving signals to/from another network entity. The signals transmitted/received with at least one of the other network entities or the UE may include at least one of control information and/or data.

Referring to FIG. 12, the processor 1201 may control the overall operation of the network entity to perform operations according to one or a combination of two or more of the embodiments of FIGS. 1 to 3 described above. The processor 1201, the transceiver 1203, and the memory 1205 are not necessarily implemented in separate modules but rather as a single chip. The processor 1201 and the transceiver 1203 may be electrically connected with each other. The processor 1201 may be an application processor (AP), a communication processor (CP), a circuit, an application-specific circuit, or at least one processor.

According to an embodiment of the disclosure, the memory 1205 may store a default program for operating the network entity, application programs, and data, such as configuration information. The memory 1205 provides the stored data according to a request of the processor 1201. The memory 1205 may include a storage medium, such as read only memory (ROM), random access memory (RAM), hard disk, compact disc (CD)-ROM, and digital versatile disc (DVD), or a combination of storage media. There may be provided a plurality of memories. The processor 1201 may perform at least one of the above-described embodiments based on a program for performing operations according to at least one of the above-described embodiments stored in the memory 1205.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

It should be noted that the above-described configuration views, example views of control/data signal transmission methods, example views of operational procedures, and configuration views are not intended as limiting the scope of the disclosure. In other words, all the components, network entities, or operational steps described in connection with the embodiments should not be construed as essential components to practice the disclosure, and the disclosure may be rather implemented with only some of the components without departing from the gist of the disclosure. The embodiments may be practiced in combination, as necessary. For example, some of the methods provided herein may be combined to operate the network entity and the UE.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for an artificial intelligence/machine learning (AI/ML) media service in a wireless communication system, the method comprising:
receiving, from a network server providing the AI/ML media service, service access information including at least one of information for media session handling and information for media streaming access;
obtaining information on client AI media inferencing capabilities and functions;
negotiating with the network server for splitting an AI media inference processing, based on the received service access information and the obtained information on client AI media inferencing capabilities and functions; and
receiving, from the network server, either intermediate data or inference output data by AI model split inferencing.

2. The method of claim 1, wherein AI model data related to a structure of an AI model for the AI/ML media service includes a UE AI model subset and a network AI model subset.

3. The method of claim 2, wherein UE AI model data corresponding to the UE AI model subset is provided to the UE by the network server.

4. The method of claim 3, further comprising:
outputting inference output data based on the UE AI model data and the received intermediate data.

5. The method of claim 3, further comprising:
outputting intermediate data by performing AI model split inferencing based on the UE AI model data; and
transmitting, to the network server, the outputted intermediate data.

6. A user equipment (UE) for an artificial intelligence/machine learning (AI/ML) media service in a wireless communication system, the UE comprising:
a transceiver; and
a processor configured to:
receive, via the transceiver from a network server providing the AI/ML media service, service access information including at least one of information for media session handling and information for media streaming access,
obtain information on client AI media inferencing capabilities and functions,
negotiate with the network server for splitting an AI media inference processing, based on the received service access information and the obtained information on client AI media inferencing capabilities and functions, and
receive, via the transceiver from the network server, either intermediate data or inference output data by AI model split inferencing.

7. The UE of claim 6, wherein AI model data related to a structure of an AI model for the AI/ML media service includes a UE AI model subset and a network AI model subset.

8. The UE of claim 7, wherein UE AI model data corresponding to the UE AI model subset is provided to the UE by the network server.

9. The UE of claim 8, wherein the processor is further configured to output inference output data based on the UE AI model data and the received intermediate data.

10. The UE of claim 8, wherein the processor is further configured to output intermediate data by performing AI model split inferencing based on the UE AI model data, and transmit, to the network server via the transceiver, the outputted intermediate data.

11. A network server for an artificial intelligence/machine learning (AI/ML) media service in a wireless communication system, the network server comprising:
a transceiver; and
a processor configured to:
transmit, to a user equipment (UE) via the transceiver, service access information including at least one of information for media session handling and information for media streaming access,
negotiate with the UE for splitting an AI media inference processing, based on the transmitted service access information, and
transmit, to the UE via the transceiver, either intermediate data or inference output data by AI model split inferencing.

12. The network server of claim 11, wherein AI model data related to a structure of an AI model for the AI/ML media service includes a UE AI model subset and a network AI model subset.

13. The network server of claim 12, wherein the processor is further configured to provide UE AI model data corresponding to the UE AI model subset to the UE.

14. The network server of claim 12, wherein the processor is further configured to output the intermediate data by performing the AI model split inferencing based on the network AI model subset.

15. The network server of claim 13, wherein the processor is further configured to:
receive, via the transceiver from the UE, intermediate data based on the UE AI model data, and
output the inference output data by performing the AI model split inferencing based on the received intermediate data and the network AI model subset.
